(19) United States
(12) Patent Application Publication
(10) Pub. No.: US 2003/0184854 A1
(43) Pub. Date: Oct. 2, 2003

(54) Optical dispension element and optical microscope

(76) Inventors: Shinji Kamimura, Hino-shi (JP); Kazuo Stoh, Saitama-shi (JP); Yoshikazu Suzuki, Toyonaka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/284,148

(22) Filed: Oct. 31, 2002

(30) Foreign Application Priority Data
Mar. 27, 2002 (JP) 2002-089387

(51) Int. Cl. G02B 21/00

(52) U.S. Cl. 359/368

(57) ABSTRACT

An optical dispersion element for obtaining a spectrum image of an image observed via an optical microscope, has two wedge glass substrates which are formed to be overlaid so that their wedge points are directed in opposite directions, and have different dispersion properties.

### CROSS-REFERENCE TO RELATED APPLICATIONS

This application is based upon and claims the benefit of priority from the prior Japanese Patent Application No. 2002-089387, filed Mar. 27, 2002, the entire contents of which are incorporated herein by reference.

### BACKGROUND OF THE INVENTION

1. Field of the Invention

The present invention relates to an optical dispersion element and optical microscope and, more particularly, to an optical dispersion element used to analyse the spectral characteristics of an image observed by an optical microscope or the like, and an optical microscope using the optical dispersion element.

2. Description of the Related Art

Upon observing biomolecular specimens via an optical microscope, and qualitatively examining the spectral characteristics of that observed image, a spectrum image is conventionally obtained using optical dispersion elements, i.e., a diffraction grating or prism.

FIGS. 1A and 1B show conventional optical dispersion elements.

A diffraction grating shown in FIG. 1A has a structure prepared by forming fine grooves on the surface of glass or the like. Light that is incident on the diffraction grating is separated by the grooves in accordance with the wavelength, thus forming diffraction patterns. Using a 1st-order diffracted image with a high intensity of the diffraction patterns, spectrometric analysis is done. The spectrometric method using a diffraction grating is used in a spectrophotometer, monochromator, or the like.

When this diffraction grating is used, light can be separated with high precision. However, in order to obtain a diffracted image with a high resolution, a special process (e.g., 20 to 30 grooves or more/mm must be formed on the diffraction grating surface) is required. Note that the intensity of incoming light attenuates several ten % when the diffraction grating is used.

A prism shown in FIG. 1B is conventionally known as a spectral optical element. Since the refractive index of a substance varies depending on the wavelength of light, the angle of refraction varies for each wavelength of light that has entered the prism. As a result, light is dispersed.

The method of separating light using a prism has the following features. Since absorption by glass is as small as several %, the intensity of incoming light attenuates little. By selecting the material and apex angle of the prism, desired dispersion properties can be easily implemented.

However, when these methods are applied to a microscope, the following problems are posed.

When these optical elements are inserted in a microscope, the optical axis changes greatly. As a result, it becomes very difficult for an observer to determine correspondence between the observed image before separation and the spectrum image after separation. Especially when a diffraction grating is used, diffracted light components of multi-orders are mixed at the same time. Therefore, it is impossible to determine correspondence between the observed image and spectrum image unless the observation area is limited to a small one.

Furthermore, since the optical axis changes greatly, it is impossible to removably insert and use such an optical element in the optical path of a general microscope unless the structure of the microscope is modified considerably.

### BRIEF SUMMARY OF THE INVENTION

It is an object of the present invention to provide an optical dispersion element which allows easy spectrometric analysis of an observed image, and can easily determine correspondence between the observed image and the spectrum image, and an optical microscope using that optical dispersion element.

According to a first aspect of the present invention there is provided an optical dispersion element comprising two wedge glass substrates which are formed to be overlaid so that wedge points are directed in opposite directions, and have different dispersion properties.

According to a second aspect of the present invention there is provided an optical microscope comprising an optical dispersion element formed to overlay two wedge glass substrates with different dispersion properties so that wedge points are directed in opposite directions, wherein optical dispersion element is inserted into an optical path of a substantially collimated light beam.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIGS. 1A and 1B show conventional optical dispersion elements;

FIG. 2 shows the structure of an optical dispersion element according to the first embodiment of the present invention;

FIG. 3 shows the refractive indices of media for respective wavelengths;

FIG. 4 shows angles of deviation for respective wavelengths;

FIG. 5 shows the arrangement of an evanescent field fluorescent microscope to which the optical dispersion element according to the present invention is applied;

FIGS. 6A and 6B respectively show observed images of fluorescent molecules and their spectrum images using the optical dispersion element;

FIG. 7 shows another embodiment of an optical dispersion element; and

FIG. 8 shows still another embodiment of an optical dispersion element.

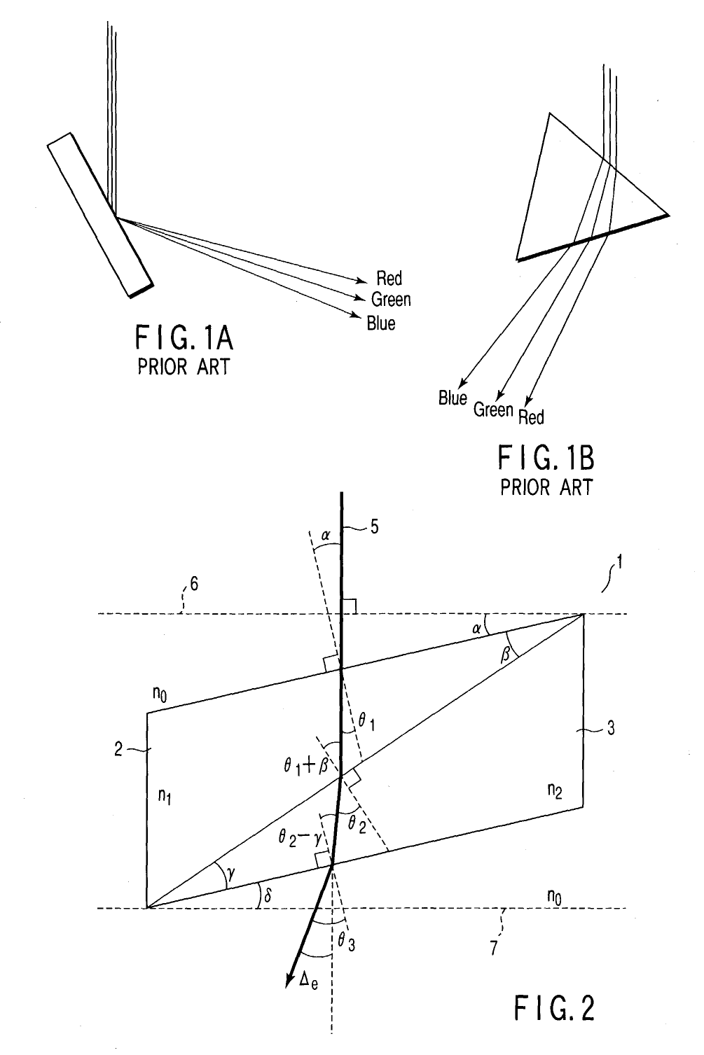

### DETAILED DESCRIPTION OF THE INVENTION

FIG. 2 shows the structure of an optical dispersion element 1 according to the first embodiment of the present invention.

An optical dispersion element 1 of this embodiment has a structure in which wedge glass substrates 2 and 3 which are formed of optical glass plates having two different dispersion properties are overlaid so that their wedge angles (to be referred to as “apex angles” hereinafter) point in opposite directions. The optical dispersion element 1 is formed so that the traveling direction of light with a specific wavelength which enters the optical dispersion element 1 is parallel to that of light of the specific wavelength which is transmitted through and leaves the optical dispersion element 1, i.e., the angle of deviation=0.

Furthermore, the positional deviation amount between the incoming light and outgoing light is very small. Hence, light of the specific wavelength, i.e., a specific color, comes near the position of a source observed image on a spectrum image obtained by the optical dispersion element 1. For this reason, the observer can easily determine correspondence between the observed image and spectrum image.

The method of forming the optical dispersion element of the present invention will be described below with reference to FIG. 2.

Let n₁ be the refractive index of the wedge glass substrate 2 which forms the optical dispersion element 1 of this embodiment, β be the apex angle of the substrate 2, n₂ be the refractive index of the wedge glass substrate 3, and γ be the apex angle of the substrate 3. Also, let α and δ be the angles planes 6 and 7 perpendicular to incoming light 5 respectively make with the wedge glass substrates 2 and 3. Furthermore, let n₀ be the refractive index of a surrounding medium.

The incoming light 5 that has entered the wedge glass substrate 2 at the angle α of incidence leaves the wedge glass substrate 3 so that the angle of deviation becomes equal to or smaller than Δe. Also, angles θ₁, θ₂, and θ₃ of refraction are defined, as shown in FIG. 2. Under such conditions, relationships given by formulas (1) to (4) hold:

sin α/sin θ₁=n₁/n₀ (1)

sin(θ₁+β)/sin θ₂=n₂/n₁ (2)

sin(θ₂−γ)/sin θ₃=n₀/n₂ (3)

|δ−θ3|<=Δe (4)

Since α, β, δ, and γ can be considered as sufficiently small angles (unit: radians) in practice, a relationship given by an approximate expression (5) can be applied. Arranging formulas (1) to (4) yields formula (6).

sin θ≈0 (5)

−Δe<δ−α−β×n₁/n₀+γ×n₂/n₀<Δe (6)

The materials, apex angles, and the like of the wedge glass substrates 2 and 3 can be determined to satisfy formula (6). Note that α, β, δ, and γ satisfy:

α+β=δ+γ (7)

Arranging formula (6) using formula (7) yields:

−Δe<−β×(n₁−n₀)/n₀+γ×(n₂−n₀)/n₀<Δe (8)

The optical dispersion element 1 is designed using this formula (8).

The types, i.e., materials, of the wedge glass substrates 2 and 3 are selected, and the refractive indices of each type for respective wavelengths are checked. Note that the refractive indices of air as a surrounding medium for respective wavelengths are also checked.

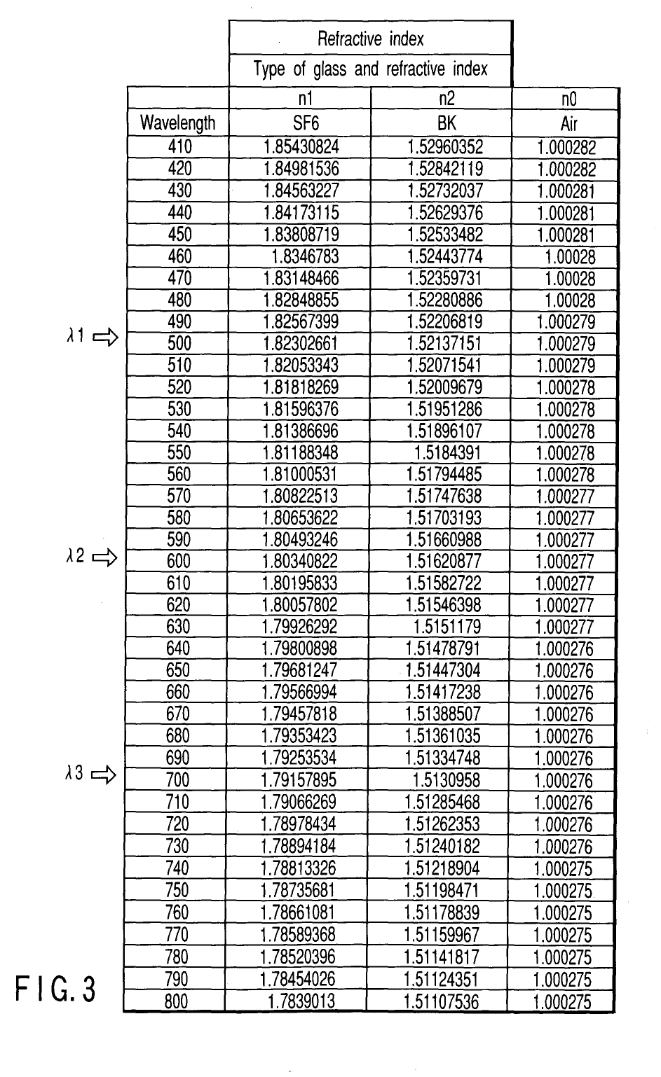

FIG. 3 shows the refractive indices of media for respective wavelengths.

In FIG. 3, λ1, λ2, and λ3 respectively indicate, e.g., green, yellow, and red light components.

A condition for light of a wavelength that makes the angle of deviation be zero is then obtained. This condition is:

−β×(n₁−n₀)/n₀+γ×(n₂−n₀)/n₀=0 (9)

That is, if the apex angles β and γ are designed to satisfy:

β/γ=(n₂−n₀)/(n₁−n₀) (10)

the angle of deviation of light of that wavelength can be zero.

Hence, the apex angles β and γ that satisfy formula (10) are specified, and the angles of deviation for respective wavelengths can be obtained by calculating formula (8) for respective wavelengths under that condition.

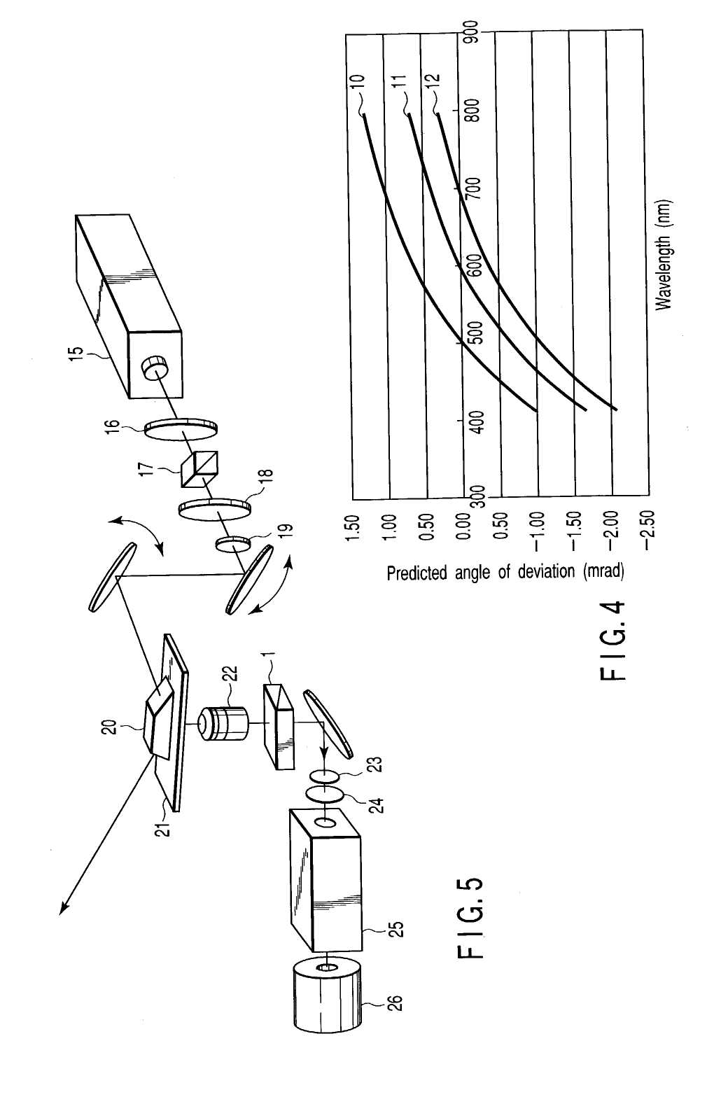

FIG. 4 shows the angles of deviation for respective wavelengths obtained by the above design calculations.

In FIG. 4, the abscissa plots the wavelengths, and the ordinate plots the angles of deviation. Characteristic curves 10, 11, and 12 respectively represent the angles of deviation of the optical dispersion element 1 for respective wavelengths, which is formed to make the angles of deviation of light components with wavelengths=500, 600, and 700 nm be zero.

Using this result, for example, the optical dispersion element 1 with the arrangement that makes the angle of deviation of light of a wavelength of 600 nm be zero can obtain the angles of deviation of light components of wavelengths of 500 and 700 nm. FIG. 4 shows the characteristic curves when SF6 and BK are used as the materials of wedge glass substrates. Also, the optical dispersion element 1 can be formed using combinations of SF6 and LAK33, SF4 and BK, quartz and BK, BK and FK1, LAK33 and BK, fluorite and BK, and the like in addition to the aforementioned combination.

Therefore, the designer can form optical dispersion elements 1 having desired spectral angles on the basis of characteristic curves under various conditions. By appropriately selecting the thickness of the optical dispersion element 1, the optical dispersion element 1 can be formed so that the positional deviation amount between incoming light and outgoing light assumes a desired value.

The arrangement and operation of an evanescent field fluorescent microscope to which the optical dispersion element 1 of this embodiment is applied will be exemplified below.

In order to analyze the functions of biomolecules, a fluorescent microscope that can generate and observe a local evanescent field is used. This optical microscope uses TIRFM (Total internal reflection fluorescent molecules microscopy) as a method of visualizing fluorescent molecules.

FIG. 5 shows the arrangement of an evanescent field fluorescent microscope to which the optical dispersion element 1 of this embodiment is applied.

A YAG laser is used as a light source for illumination 15 that excites samples. The plane of polarization of a generated laser beam (532 nm) is rotated by a λ/2 wave plate 16. That laser beam then enters a λ/4 plate 18 via a beam splitter 17. The laser beam attenuates since its plane of polarization has been rotated and the beam has been transmitted through the beam splitter 17. Since the laser beam is linearly polarized, it is converted into circularly polarized light using the λ/4 wave plate 18. Use of the λ/4 wave plate 18 is to avoid the influences such as variations in fluorescent intensity of fluorescent molecules and the like.

The laser beam strikes a quartz block 20 via a collector lens 19 and a pair of reflection mirrors. A quartz slide glass 21 on which fluorescent molecules as a specimen are fixed is provided on the lower surface side of this quartz block 20. The gap between the quartz block 20 and quartz slide glass 21 is filled with pure glycerol.

The laser beam forms an evanescent field as a local region while being repetitively reflected between the quartz slide glass 21 and a sample solution, thus exciting fluorescent molecules present in that field. The laser beam then leaves the quartz block 20 as reflected light.

An objective lens 22 is used to observe the behavior of the excited fluorescent molecules. From the image of the objective lens 22, the influences of scattered light and background light are removed by a bandpass filter 23. After that, the image of the objective lens 22 is projected onto a CCD image sensing element 26, which is combined with an image intensifier 25, via a relay lens 24, and undergoes an image process by an image processing apparatus (not shown).

The optical dispersion element 1 of this embodiment can be easily inserted into or removed from the optical path between the objective lens 22 and relay lens 24. In this embodiment, this optical dispersion element 1 is designed to make the angle of deviation of light of a wavelength corresponding to green be zero. For this reason, light of the wavelength corresponding to green is also formed on a spectrum image near the position of a source image.

In this manner, merely by inserting or removing the optical dispersion element 1 of this embodiment into or from the optical path, observed images and spectrum images can be easily obtained. Upon assembling the optical dispersion element 1 of this embodiment, the structure of a conventional microscope need not be largely modified.

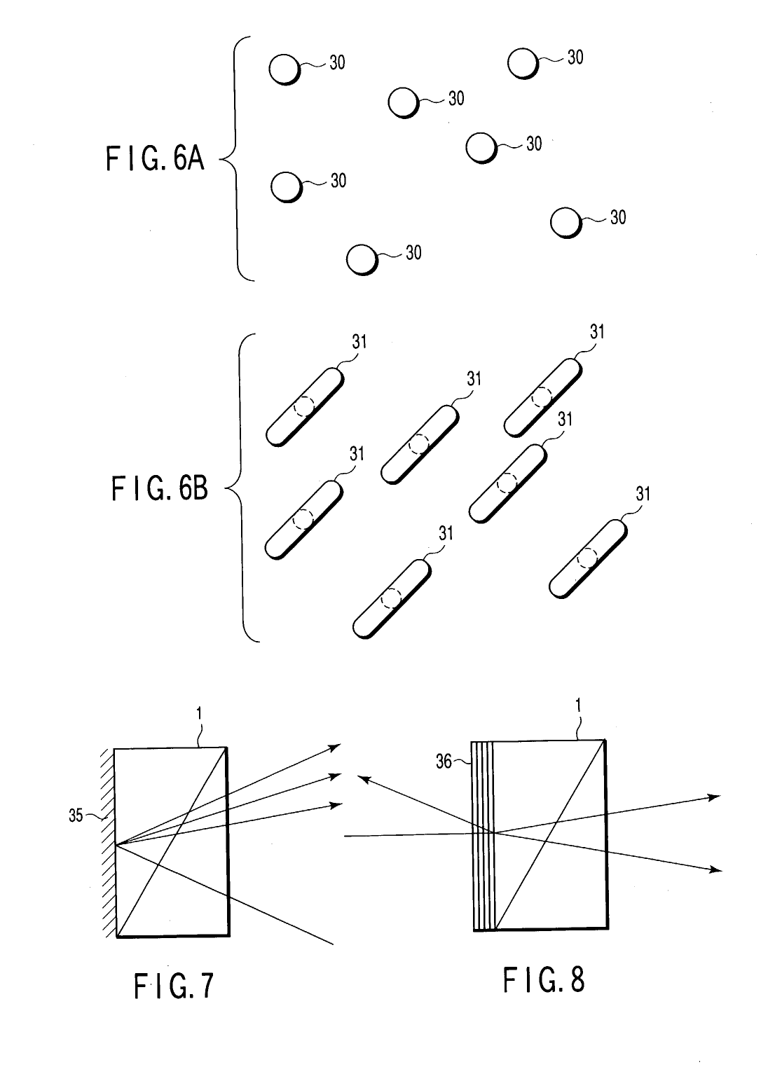

FIGS. 6A and 6B respectively show observed images of fluorescent molecules, and their spectrum images using the optical dispersion element 1.

FIG. 6A shows the observed images of fluorescent molecules 30, which are observed without using the optical dispersion element 1. In these observed images, the fluorescent molecules 30 are expressed as small orange dots. When the optical dispersion element 1 is inserted into the optical path in this state, spectra 31 for respective fluorescent molecules appear, as shown in FIG. 6B. Since fluorescence emitted by these fluorescent molecules 30 contain wavelength components in a broad region of the visible range, band images of green, yellow, red, and the like, which appear in the spectrum images, can be clearly identified. The luminance distribution on the observed images is measured as needed to quantitatively analyze the spectral characteristics.

In this embodiment, the observed image and spectrum images are switched by inserting or removing the optical dispersion element 1 into or from the optical path of a substantially collimated light beam. However, the present invention is not limited to such a specific embodiment. For example, the optical dispersion element 1 may be inserted into one optical path split by a beam splitter inserted into the optical path. With this arrangement, the observed image and spectrum images can be observed at the same time.

Even when the present invention is used, spectrum images can be recorded and analyzed using a video or still camera. When green light of a wavelength of 567 nm and red light of a wavelength of 670 nm are to be separated at an angle of 9°, a wedge glass substrate which is formed of SF6 with an apex angle of 9°, and a wedge glass substrate which is formed of BK7 with an apex angle of 10.05° are used. When the optical dispersion element with this arrangement is used, light of the wavelength of 567 nm and that of the wavelength of 670 nm can be separately observed as two dots or two spots separated by 0.44 mm on the imaging surface separated by 200 mm.

As a result, a change in spectrum image along with an elapse of time can be recorded using a high-sensitivity video camera. In this way, a spectral change in a single fluorescent molecule of, e.g., a FRET (fluorescence resonance energy transfer) phenomenon can be continuously observed.

Note that the optical dispersion element according to the present invention is not limited to the arrangement described in the above embodiment, and can be varied.

FIG. 7 shows another embodiment of an optical dispersion element.

In this embodiment, a reflection coat 35 is formed on one surface of a wedge glass substrate, and separated reflected light components can be obtained. Hence, this optical dispersion element can be applied to an optical device such as a reflecting microscope.

FIG. 8 shows still another embodiment of an optical dispersion element.

In this embodiment, a reflection coat 36 is formed on one surface of a wedge glass substrate, and only light components of some wavelengths are selectively reflected. Hence, this optical dispersion element is effective when observation is to be made while removing the influence of specific light.

As described above, merely by inserting the optical dispersion element of this embodiment into the optical path, spectrometric analysis of specimens under observation can be easily made, and correspondence with observed images before insertion can be easily determined. Therefore, the optical dispersion element of this embodiment can be widely applied in addition to a single fluorescent molecules analysis apparatus. For example, the optical dispersion element of this embodiment can be applied to optical microscopes such as a darkfield microscope, bright field microscope, fluorescence microscope, and the like, fractionators assembled with optical systems such as a cell sorter, micro flow cell, and the like, a micro spectrophotometer, and the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical dispersion element for obtaining a spectrum image of an object image observed via an optical microscope, comprising:
two wedge glass substrates which are formed to be overlaid so that wedge points are directed in opposite directions, and have different dispersion properties.

2. An element according to claim 1, wherein a traveling direction of light with a specific wavelength, which leaves the optical dispersion element, is parallel to a traveling direction of light with a specific wavelength, which enters the optical dispersion element.

3. An element according to claim 1, wherein wedge angles β and γ of the two wedge glass substrates, refractive indices n₁ and n₂ Of the two wedge glass substrates for light of a specific wavelength, and a refractive index no of a surrounding medium satisfy:
β/γ=(n₂−n₀)/(n₁−n₀)

4. An element according to claim 2, wherein wedge angles β and γ of the two wedge glass substrates, refractive indices n₁ and n₂ of the two wedge glass substrates for light with a specific wavelength, and a refractive index no of a surrounding medium satisfy:
β/γ=(n₂−n₀)/(n₁−n₀)

5. An optical microscope comprising:
an optical dispersion element formed to overlay two wedge glass substrates with different dispersion properties so that wedge points are directed in opposite directions,
wherein the optical dispersion element is inserted into an optical path of a substantially collimated light beam.

6. A microscope according to claim 5, wherein a traveling direction of light with a specific wavelength, which leaves the optical dispersion element, is parallel to a traveling direction of light with a specific wavelength, which enters the optical dispersion element.

7. A microscope according to claim 5, wherein wedge angles β and γ of the two wedge glass substrates, refractive indices n₁ and n₂ of the two wedge glass substrates for light with a specific wavelength, and a refractive index no of a surrounding medium satisfy:
β/γ=(n₂−n₀)/(n₁−n₀)

8. A microscope according to claim 6, wherein wedge angles β and γ of the two wedge glass substrates, refractive indices n₁ and n₂ of the two wedge glass substrates for light with a specific wavelength, and a refractive index no of a surrounding medium satisfy:
β/γ=(n₂−n₀)/(n₁−n₀)

9. A microscope according to claim 5, wherein the optical dispersion element can be inserted into or removed from an optical path of a substantially collimated light beam.

10. A microscope according to claim 9, wherein a traveling direction of light with a specific wavelength, which leaves the optical dispersion element, is parallel to a traveling direction of light with a specific wavelength, which enters the optical dispersion element.

11. A microscope according to claim 9, wherein wedge angles β and γ of the two wedge glass substrates, refractive indices n₁ and n₂ of the two wedge glass substrates for light with a specific wavelength, and a refractive index no of a surrounding medium satisfy:
β/γ=(n₂−n₀)/(n₁−n₀)

12. A microscope according to claim 10, wherein wedge angles β and γ of the two wedge glass substrates, refractive indices n₁ and n₂ of the two wedge glass substrates for light with a specific wavelength, and a refractive index no of a surrounding medium satisfy:
β/γ=(n₂−n₀)/(n₁−n₀)

13. A microscope according to claim 5, wherein the optical microscope is an evanescent field fluorescent microscope.

14. A microscope according to claim 13, wherein a traveling direction of light with a specific wavelength, which leaves the optical dispersion element, is parallel to a traveling direction of light with a specific wavelength, which enters the optical dispersion element.

15. A microscope according to claim 13, wherein wedge angles β and γ of the two wedge glass substrates, refractive indices n₁ and n₂ Of the two wedge glass substrates for light with a specific wavelength, and a refractive index no of a surrounding medium satisfy:
β/γ=(n₂−n₀)/(n₁−n₀)

16. A microscope according to claim 14, wherein wedge angles β and γ of the two wedge glass substrates, refractive indices n₁ and n₂ of the two wedge glass substrates for light with a specific wavelength, and a refractive index n₀ of a surrounding medium satisfy:
β/γ=(n₂−n₀)/(n₁−n₀)

17. A microscope according to claim 9, wherein the optical microscope is an evanescent field fluorescent microscope.

18. A microscope according to claim 17, wherein a traveling direction of light with a specific wavelength, which leaves the optical dispersion element, is parallel to a traveling direction of light with a specific wavelength, which enters the optical dispersion element.

19. A microscope according to claim 17, wherein wedge angles β and γ of the two wedge glass substrates, refractive indices n₁ and n₂ of the two wedge glass substrates for light with a specific wavelength, and a refractive index n₀ of a surrounding medium satisfy:
β/γ=(n₂−n₀)/(n₁−n₀)

20. A microscope according to claim 18, wherein wedge angles β and γ of the two wedge glass substrates, refractive indices n₁ and n₂ of the two wedge glass substrates for light with a specific wavelength, and a refractive index n₀ of a surrounding medium satisfy:
β/γ=(n₂−n₀)/(n₁−n₀)
